(19) United States
(12) Patent Application Publication
(10) Pub. No.: US 2023/0322020 A1
(43) Pub. Date: Oct. 12, 2023

(54) A WHEEL

(71) Applicant: Zak Mobility Ltd., Newark, Nottinghamshire (GB)

(72) Inventor: Samuel Blackburn PEARCE, Newark, Nottinghamshire (GB)

(21) Appl. No.: 18/004,127

(22) PCT Filed: Jul. 2, 2021
(86) PCT No.: PCT/GB2021/051688

§ 371 Date: Jan. 3, 2023

(30) Foreign Application Priority Data
Jul. 3, 2020 (GB) 2010231.5

(51) Int. Cl. B60B 9/04; B60B 9/08

(52) U.S. Cl. CPC B60B 9/04; B60B 9/08

(57) ABSTRACT

A wheel includes a wheel rim, a hub defining a hollow housing for a wheel mount, and three or more resilient and equidistantly spaced spokes extending between an outer circumferential surface of the hub and an inner circumferential surface of the wheel rim. Each spoke is defined by a flexed, elongate spring element having a length that is greater than the radial distance between the outer circumferential surface of the hub and the inner circumferential surface of the wheel rim. The spring element is tangentially fixed at or towards one end to the outer circumferential surface of the hub and tangentially coupled at or towards its other end to the inner circumferential surface of the wheel rim via a hinged connection. The tangential coupling at the wheel rim is spaced circumferentially from the tangential fixing at the hub in a predetermined direction by a predetermined angle.

The invention relates to a wheel and, more particularly; a wheel having in-built, integrated suspension capabilities,

Wheel-based vehicles and machinery often experience shock and/or a loss of control when one or more of the wheels is subjected to an impact or is driven over an uneven driving surface. In order to overcome this problem such vehicles and machinery are often equipped with suspension systems including springs and dampers connected to each of the wheels so as to absorb impacts and to assist in the control of the wheels. The inclusion of such suspension also helps to ensure that the wheels of such vehicles and machinery remain in contact with a driving surface, regardless of the condition of the surface, and thereby helps to ensure the comfort and well-being of any occupants.

Conventionally the suspension systems used are distinct apparatus connected to each of the wheels. The inclusion of one or more suspension systems therefore increases the size, weight and manufacturing costs of wheel-based vehicles and machinery,

According to an aspect of the invention there is provided a wheel including;
a wheel rim;
a hub defining a hollow housing for a wheel mount; and
three or more resilient and equidistantly spaced spokes extending between an outer circumferential surface of the hub and an inner circumferential surface of the wheel rim;
wherein each spoke is defined by a flexed, elongate spring element having a length that is greater than the radial distance between the outer circumferential surface of the hub and the inner circumferential surface of the wheel rim, the spring element being tangentially fixed at or towards one end to the outer circumferential surface of the hub and tangentially coupled at or towards it other end to the inner circumferential surface of the wheel rim via a hinged connection, the tangential coupling at the wheel rim being spaced circumferentially from the tangential fixing at the hub in a predetermined direction by a predetermined angle, such that the hub is biased to a centrally located position within the wheel rim in an unloaded condition whilst allowing radial movement of the hub relative to the wheel rim in a loaded condition.

The resilient nature of the spokes, which allows radial movement of the hub relative to the wheel rim in a loaded condition whilst biasing the hub towards a centrally located position in an unloaded condition, provides an integrated suspension system that allows the wheel to absorb external forces that might be encountered, for example, during driving movement of the wheel over an uneven surface. This removes the need for external suspension and therefore reduces the number of components that would otherwise be associated with the wheel, thereby resulting in size and cost benefits.

It will be appreciated that the use of at least three equidistantly spaced spokes results in a balanced configuration that resists rotation of the hub relative to the wheel rim whilst maintaining the hub at a centrally located position relative to the wheel rim in an unloaded configuration.

The manner in which each of the spring elements is connected between the outer circumferential surface of the hub and the inner circumferential surface of the wheel rim controls the extent to which the spring element used to form each spoke might flex and deform during the application of a load to the wheel that results in movement of the hub relative to the wheel rim, thereby further improving the stability of the wheel.

More specifically, the rigid tangential connections of the spokes at the hub improves the lateral stability of the wheel, reducing the risk of any twisting movement of the hub relative to the wheel rim.

In addition, the hinged tangential couplings at the wheel rim allows pivoting movement of the spring element relative to the wheel rim and reduces the stresses applied to the spring element during flexure of the spring element. It therefore reduces the risk of the spring elements snapping and allows the use of a material that is less flexible than might otherwise be required if the spring elements were rigidly connected to the wheel rim.

It will be appreciated that the lateral stability (otherwise known as lateral stiffness) of a wheel in which the hub is mounted for movement relative to the wheel rim is inevitably reduced when compared with a conventional wheel construction in which the hub is fixed relative to the wheel rim. It is important, therefore, that the spring elements locate the hub relative to the wheel rim in a manner that maximises lateral stability of the wheel in so far as it is possible. Inevitably, the use of fixed connections to secure the opposing ends of each spring element to the hub and the wheel rim will maximise the lateral stiffness of the resultant wheel. The use of a fixed connection at both ends of the spring elements results in a disproportionate increase in the spring compression rate of each spring element—i.e. the change in load per unit of deflection—and so a disproportionate increase in the spring compression rate of the integrated suspension system of the wheel.

This means that if fixed connections are used at both the hub and the wheel rim, softer (i.e. more flexible) spring elements are required in order to reduce the spring compression rate sufficiently to allow movement of the hub relative to the wheel rim and thereby provide an integrated suspension system, particularly in applications where a relatively low spring rate is required—i.e. for use in a bicycle or moped. Reducing the strength of the spring elements, however, makes the spring elements less able to resist rotation of the hub relative to the wheel rim when the wheel is driven to rotate on an axle extending through the hub such that the spring elements are more prone to breakage on application of a driving force to the wheel via the hub.

The relatively low increase in lateral stiffness achieved through the use of fixed connections at both the hub and the wheel rim is not, therefore, sufficient to offset the risk of the spring elements breaking in use. In contrast the use of hinged connections at the wheel rim, allowing pivoting movement of the spring elements relative to the wheel rim, results in a lower spring compression rate when compared with the use of fixed connections at both the hub and the wheel rim. Accordingly, the use of a hinged connection between each spring element and the wheel rim allows the use of a stiffer—and therefore stronger—spring element.

The use of a hinged connection to couple each spring element to the wheel rim also results in a smoother and more uniform stress loading of the spring elements when the wheel is driven to rotate on an axle extending through the hub when compared with the use of a fixed connection at the wheel rim. The use of a fixed connection results in localized stress loading and so causes more rapid fatiguing of the spring elements and a greater risk of wheel failure. High stress loading of a spring element will create fatigue within the spring element structure and cause the spring element eventually to fail. In contrast, the use of a hinged connection to couple each spring element to the wheel rim allows for better fatigue management of the spring elements whilst also achieving a sufficient degree of lateral stiffness in the resultant wheel.

In particularly preferred embodiments, the wheel includes only three resilient and equidistantly spaced spokes extending between the outer circumferential surface of the hub and the inner circumferential surface of the wheel rim.

Preferably, each spring element may be formed from a laminated structure including one or more alternate layers of reinforcing material and epoxy resin in order to achieve the required resilience.

In such embodiments, the reinforcing material may be chosen from glass fibre, carbon fibre, Kevlar (RTM) and hemp, and the reinforcing material is preferably arranged within the laminated structure so as to follow the shape of the spring element so as to provide a uni-directional strengthening effect and to enhance the performance of the spring element.

The applicant has discovered that the stability of the wheel may be improved by arranging the spring element of each spoke to extend between the outer circumferential surface of the hub and the inner circumferential surface of the wheel rim such that the predetermined angle by which the tangential coupling at the wheel rim is spaced circumferentially from the tangential fixing at the hub is in the range of 100° to 110°.

Preferably, the length of the spring element of each spoke is selected so that the resultant flexure of the spring element between the tangential coupling at the wheel rim and the tangential fixing at the hub causes the spring element to pass through a midpoint between the outer circumferential surface of the hub and the inner circumferential surface of the wheel rim at a midpoint of the circumferential spacing of the tangential fixing at the hub from the tangential coupling at the wheel rim. These relative dimensions result in a particularly stable arrangement when the wheel is subject to the torques that might be encountered on a driven vehicle, whether that be a motor-driven wheel or a manually-driven wheel.

In order to further improve the lateral stability of the wheel, and reduce the risk of twisting of the hub relative to the wheel rim, the radial dimension of the hub relative to the inside radial dimension of the wheel rim may be selected so that the diameter of the hub is between 60% and 80% of the inside diameter of the wheel rim.

The use of a relatively large hub when compared with the overall size of the wheel envelope defined by the wheel rim reduces the space in which the spokes are received and greatly assists in increasing the lateral stability of the wheel.

It is envisaged that in embodiments of the invention the diameter of the hub may be 70% or 80% of the inside diameter of the wheel rim. In particularly preferred embodiments of the invention, however, the applicant has discovered that the lateral stability of the wheel is optimised through the use of a hub having a diameter that is 60% of the inside diameter of the wheel rim.

The provision of a hub defining a hollow housing for a wheel mount allows the wheel to be used to replace an existing wheel in that it allows the existing wheel fixture for mounting the wheel to be housed in the hub and thereby provide a direct replacement for an existing wheel without modification of the mechanism used to mount the wheel.

Preferably, a wheel mount in fixed in the housing defined by the hub and an axle is coupled to the wheel mount for connection to a vehicle.

In the case of a manually driven vehicle, such as a wheelchair, stroller or trolley, for example, the wheel mount might include an outwardly projecting pin that is received in a complementarily shaped and sized socket on the vehicle.

The lateral stability achieved by the relative dimensions of the wheel rim, hub and resilient spokes means that a wheel according to the invention is able to withstand greater torques than might otherwise be achieved on a manually driven vehicle. Accordingly, in particularly preferred embodiments, the wheel mount further includes an electric hub motor configured to drive rotation of the hub on the axle.

It will be appreciated that, in such embodiments, the axle does not rotate with the wheel and so must be fixably received in a vehicle in order to allow driven movement of the vehicle on rotation of the wheel.

The provision of an electric hub motor within the wheel, in combination with the suspension capabilities provided by the resilient spokes, results in a greatly simplified wheel structure and allows the wheel, for example, to be mounted in a cambered configuration whilst still achieving the desired functionality of the wheel.

In such embodiments, braking of the rotation of the hub on the axle may be achieved through electric braking of the motor.

In other embodiments, braking of the rotation of the hub on the axle may be achieved through the use of a more conventional brake disc assembly. In such embodiments, a brake disc may be mounted on an outer face of the wheel mount for rotation with hub in a plane generally parallel to but spaced from the hub.

It is envisaged that each spring element may be tangentially coupled at or towards its other end to the inner circumferential surface of the wheel rim via a mechanical hinge. It will be appreciated, however, that mechanical hinges would require servicing in order to ensure proper functioning of the pivoting connection between the spring element and the inner circumferential surface of the wheel rim. Accordingly, in other embodiments, it is envisaged that a non-mechanical hinge might be used in order to couple the spring element to the inner circumferential surface of the wheel rim.

Preferred embodiments of the invention will now be described with reference to the accompanying drawings in which:

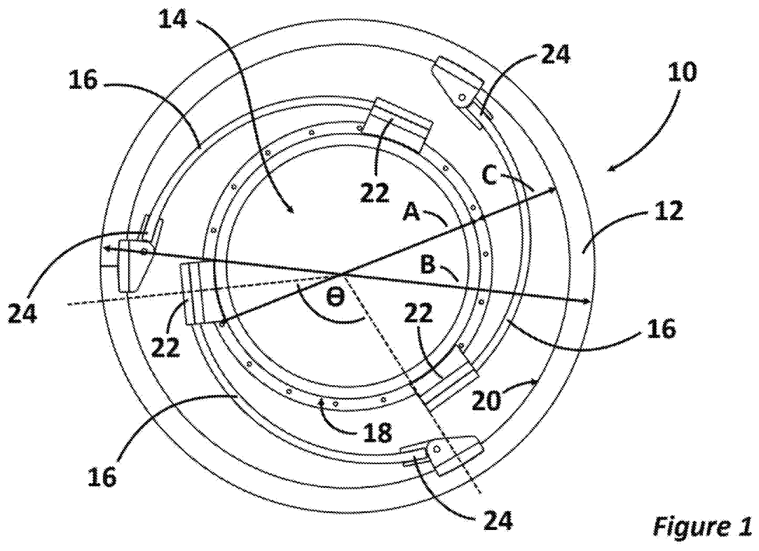

FIG. 1 shows an elevational view of a first side of a wheel according to a first embodiment of the invention;

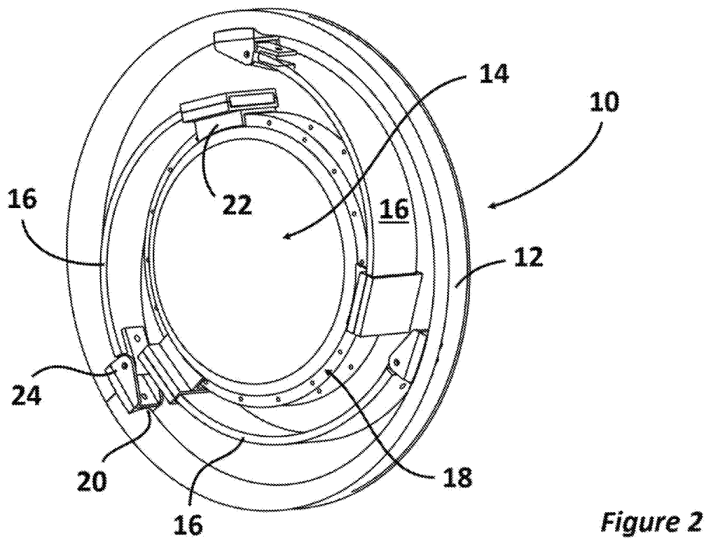

FIG. 2 shows a perspective view of the first side of the wheel shown in FIG. 1;

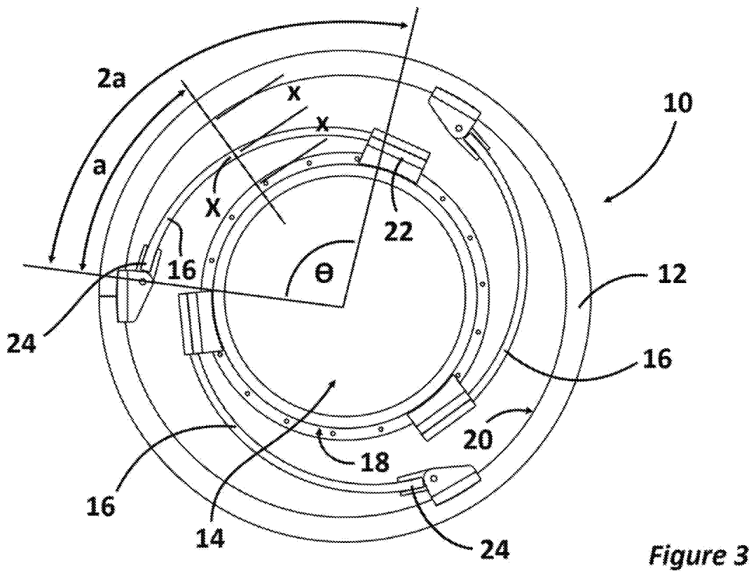

FIG. 3 shows a further perspective view of the first side of the wheel shown in FIG. 1;

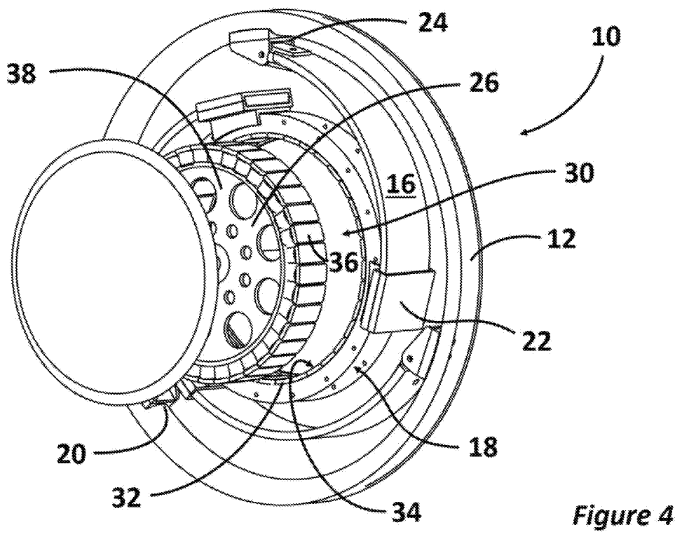

FIG. 4 shows an exploded perspective view of the first side of the wheel shown in FIG. 1;

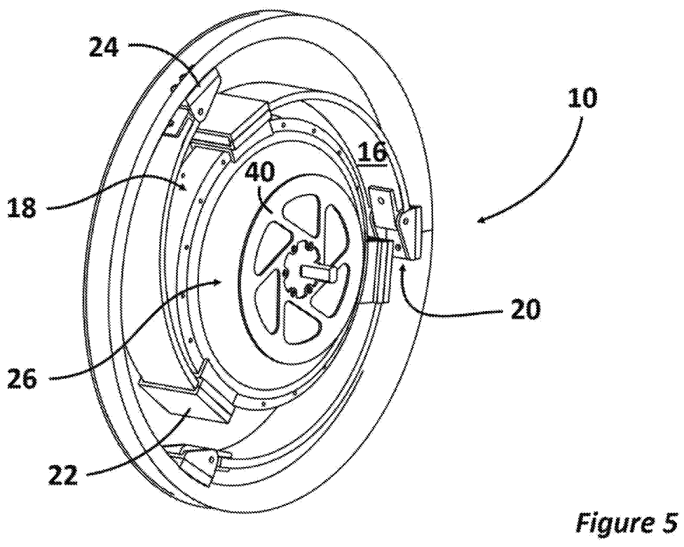

FIG. 5 shows an elevational view of a second, opposite, side of the wheel shown in FIG. 1;

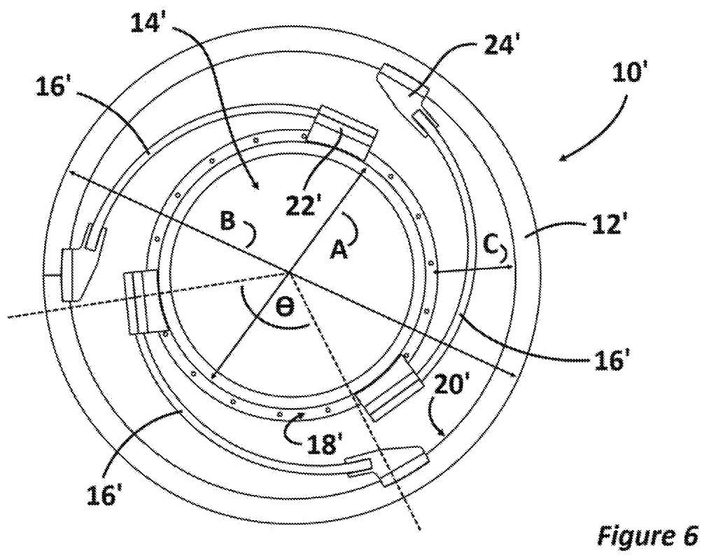

FIG. 6 shows an elevational view of a first side of a wheel according to a second embodiment of the invention;

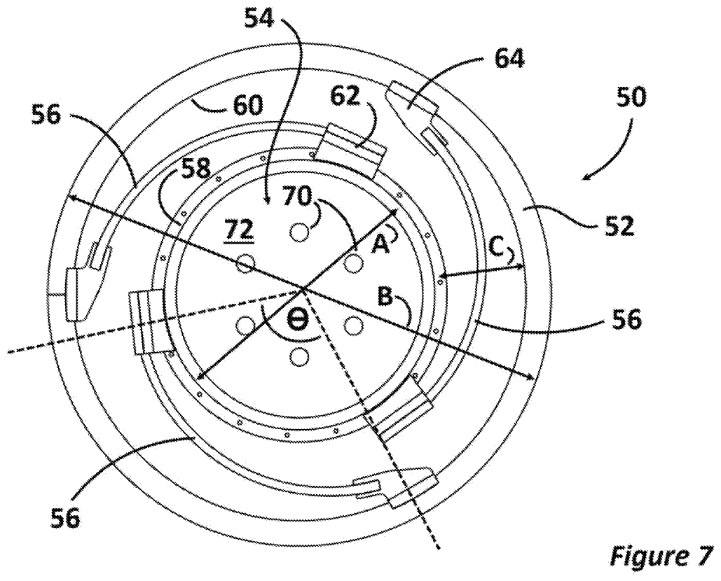

FIG. 7 shows an elevational view of a first side of a wheel according to a third embodiment of the invention;

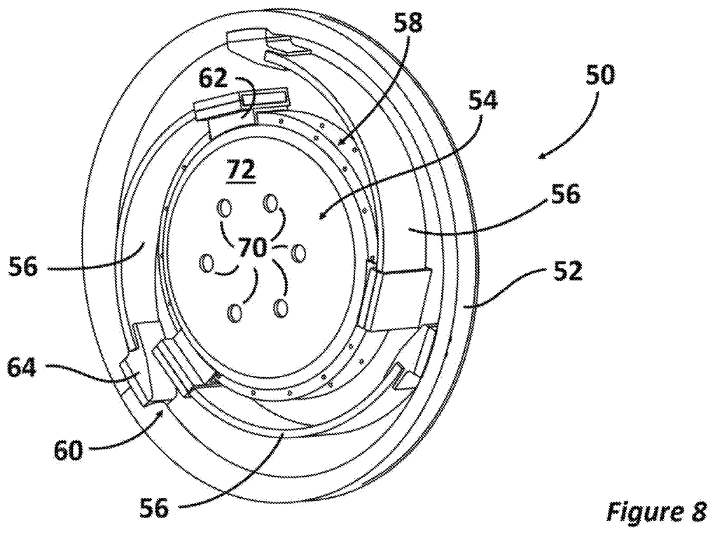

FIG. 8 shows a perspective view of the first side of the wheel shown in FIG. 7;

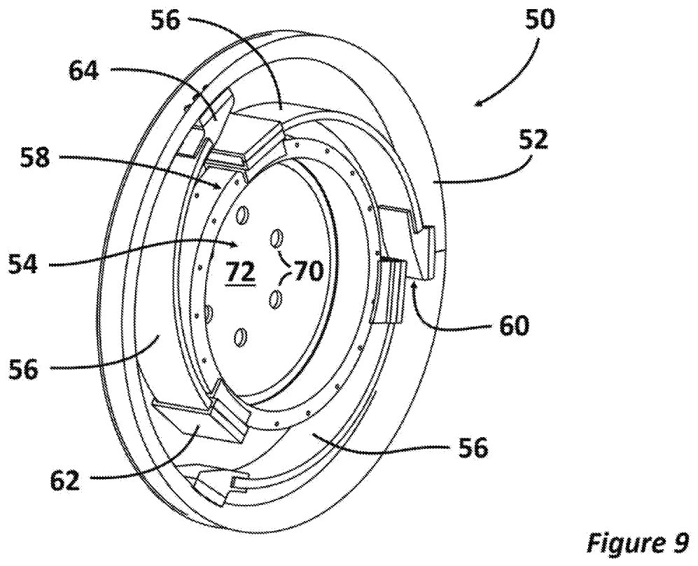

FIG. 9 shows a perspective view of a second, opposite, side of the wheel shown in FIG. 7; and

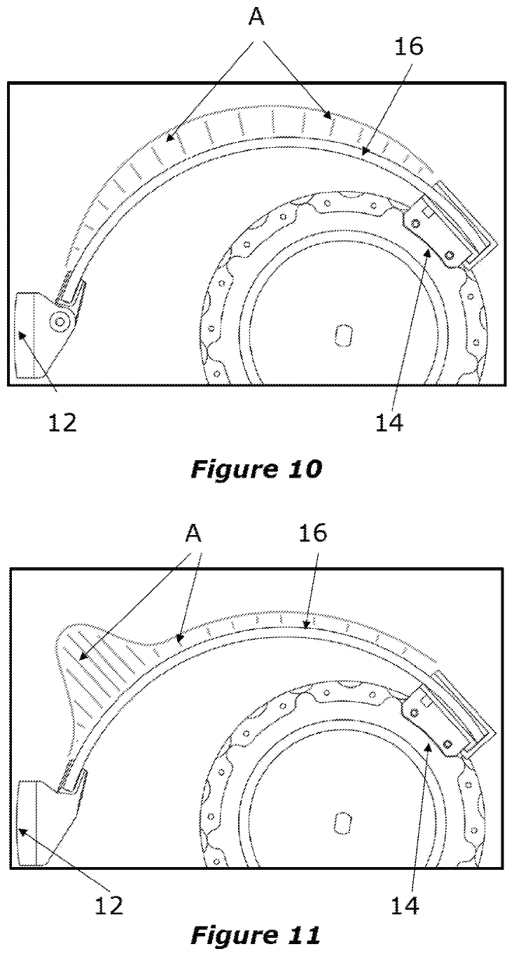

FIG. 10 provides a schematic illustration of stress loading along the length of a spoke fixedly connected at one end to the hub of a wheel and hingedly connected at the other end to the wheel rim when the wheel is driven to rotate on an axle extending through the hub;

FIG. 11 provides a schematic illustration of localised stress loading of a spoke fixedly connected at one end to the hub of a wheel and and fixedly connected at the other end to the wheel rim when the wheel is driven to rotate on an axle extending through the hub;

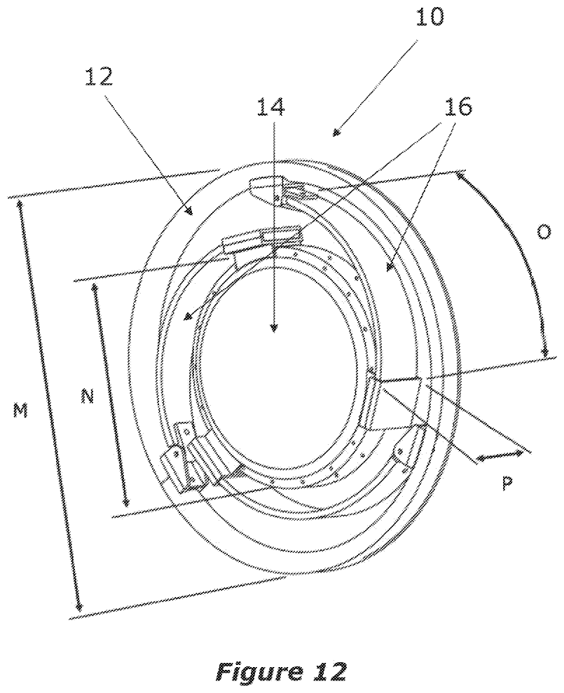

FIG. 12 illustrates the dimensions of a wheel used to measure spring compression rate and lateral stiffness of the wheel;

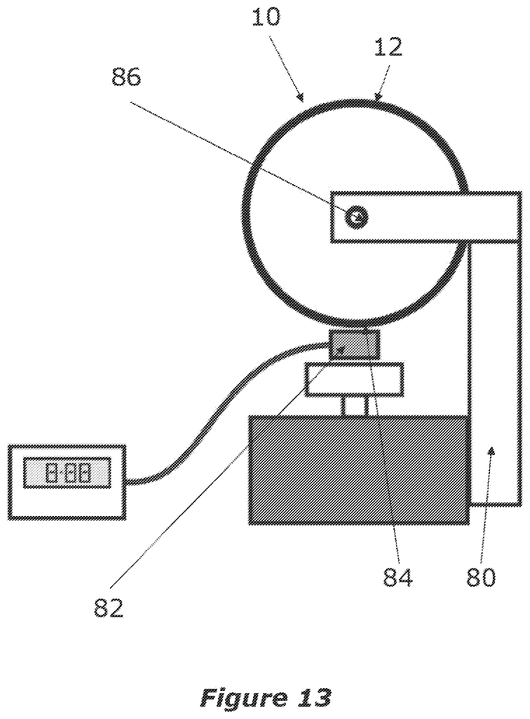

FIG. 13 illustrates the experimental set up of instruments employed to measure spring compression rate of the wheel; and

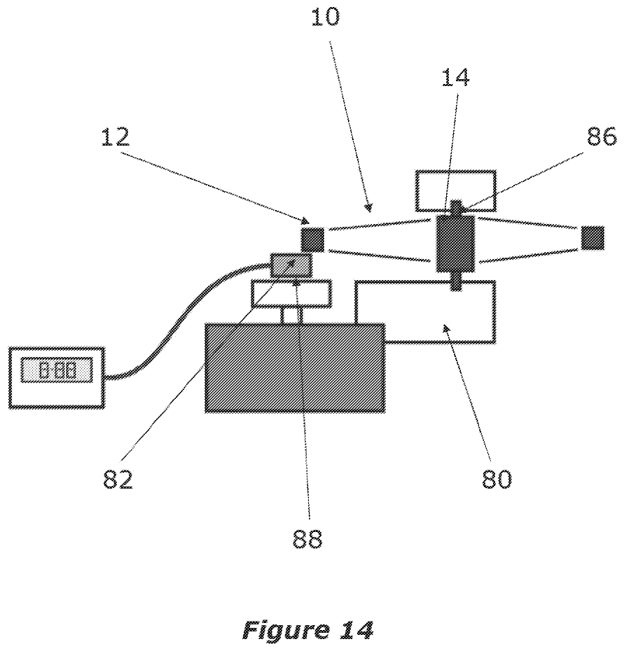

FIG. 14 illustrates the experimental set up of instruments employed to measure lateral stiffness of the wheel.

A wheel 10 according to a first embodiment of the invention is shown in FIGS. 1 and 2. The wheel 10 includes a wheel rim 12 and a hub 14 defining a hollow housing for a wheel mount 26 (FIG. 5).

The hub 14 is mounted within the wheel rim 12 via three resilient and equidistantly spaced spokes 16 extending between an outer circumferential surface 18 of the hub 14 and an inner circumferential surface 20 of the wheel rim 12. Each spoke 16 is defined by a flexed, elongate spring element having a length that is greater than the radial distance C between the outer circumferential surface 18 of the hub 14 and the inner circumferential surface 20 of the wheel rim 12.

Each elongate spring is tangentially fixed at or towards one end 22 to the outer circumferential surface 18 of the hub 14 and tangentially coupled at or towards its other end 24 to the inner circumferential surface 20 of the wheel rim 12 via a hinged connection provided by means of a mechanical hinge.

The tangential coupling at the wheel rim 12 is spaced circumferentially from the tangential fixing at the hub 14 in an anti-clockwise direction by an angle θ.

The size of the angle θ may vary depending on the behaviour and performance required by the spring elements. In the embodiment shown in FIG. 1, the angle θ subtended by the connections at the opposing ends of the spring element of each spoke 16 is 110°.

In other embodiments, the angle θ subtended by the connections at the opposing ends of the spring element of each spoke 16 may be in the range of 100° to 110°.

As can be seen from FIGS. 1 and 2, the equidistantly spaced arrangement of the spokes 16 means that the hub 14 is biased to a centrally located position within the wheel rim 12 in an unloaded condition whilst allowing radial movement of the hub 14 relative to the wheel rim 12 in a loaded condition.

It will be appreciated that when a load is applied to the hub 14, such as might occur when the wheel is driven over an uneven driving surface, the resilient nature of the spring elements used to form spokes 16 will allow movement of the hub 14 relative to the wheel rim 12. The resilient nature of the spring elements biasing the hub 14 towards its centrally located position within the wheel rim 12 will also act to dampen any resultant oscillatory movement of the hub 14 relative to the wheel rim 12. Accordingly, the spokes 16 act to define an integrated suspension system within the structure and confines of the wheel envelope defined by the wheel rim 12.

The fixed connection between each spring element and the outer circumferential surface 18 of the hub 14 improves the lateral stability of the wheel 10, reducing the risk of any twisting movement of the hub 14 relative to the wheel rim 12.

The hinged tangential coupling between the spring element of each spoke 16 and the inner circumferential surface 20 of the wheel rim 12 allows pivoting movement of the spring element relative to the wheel rim 12 and reduces the stresses applied to the spring element during flexure of the spring element. It therefore reduces the risk of the spring elements snapping and allows the use of a material that is less flexible than might otherwise be required if the spring elements were rigidly connected to the wheel rim 12.

In the embodiment shown in FIGS. 1 and 2, the spring element of each spoke 16 is formed from a laminated structure including one or more alternate layers of reinforcing material and epoxy resin in order to achieve the desired resilience.

The length of the spring element of each spoke 16 is selected so that the flexure of the spring element between the tangential coupling at the wheel rim 12 and the tangential fixing at the hub 14 causes the spring element to pass through a midpoint between the outer circumferential surface 18 of the hub 14 and the inner circumferential surface 20 of the wheel rim 12 at a midpoint of the circumferential spacing of the tangential fixing at the hub 14 from the tangential coupling at the wheel rim 12. This arrangement improves the lateral stability of the wheel 10 and assists in the resistance to any twisting movement of the hub 14 relative to the wheel rim 12.

The midpoint between the outer circumferential surface 18 of the hub 14 and the inner circumferential surface 20 of the wheel rim 12 is identified as X in FIG. 3, the midpoint X between spaced by an equal distance, identified as x, from both the outer circumferential surface 18 of the hub 14 and the inner circumferential surface 20 of the wheel rim 12.

As shown in FIG. 3, this midpoint X is located an equal circumferential distance, identified as a, from both the tangential fixing at the hub 14 and the tangential coupling at the wheel rim 12. Accordingly, the circumferential distance of the tangential fixing at the hub 14 from the tangential coupling at the wheel rim 12 is identified as 2a in FIG. 3.

The lateral stability of the wheel 10 is further improved by the radial dimension of the hub 14 relative to the radial dimension of the wheel rim 12. In the embodiment shown in FIGS. 1 and 2, the diameter A of the hub 14 is 60% of the inside diameter B of the wheel rim 12. This results in a reduced space between the outer circumferential surface 18 of the hub 14 and the inner circumferential surface of the wheel rim 12, than might otherwise be the case with a more conventionally sized hub, to receive the spokes 16. This greatly assists in increasing the lateral stability of the wheel 10.

In other embodiments of the invention, the diameter A of the hub 14 may be between 60% and 80% of the inside diameter B of the wheel rim 12. The diameter A of the hub 14 may, for example, be 70% or 80% of the inside diameter B of the wheel rim 12. It is preferred, however, that the diameter A of the hub 14 is 60% of the inside diameter B of the wheel rim 12.

Referring to FIG. 5, it can be seen that the hub 14 houses a wheel mount 26 including an outwardly projecting axle 28 for engagement within a corresponding shaped socket in a vehicle (not shown).

Referring to FIG. 4, it can be seen that the wheel mount 26 includes an electric hub motor 30 that is configured to drive rotation of the hub 14 relative to the axle 28. More specifically, the electric hub motor 30 includes a plurality of permanent magnets 32 mounted around an inner circumferential surface 34 of the hub 14. A plurality of coils 36 are mounted on a stator 38, which is in turn mounted on and fixed to the axle 28.

On the application of an alternating current to the coils 36, subject to careful control, the permanent magnets 32 can be driven to rotate around the coils 36, thereby driving rotation of the hub 14 on the axle 28.

The driving force applied to the hub 14 by the hub motor 30 results in torsional loading of the hub 14 that tends to drive rotation of the hub 14 relative to the wheel rim 12. The nature of the connections between the spring elements of spokes 16 with the hub 14 and the wheel rim 12, as well as the dimensions of the spring element of spokes 16 relative to the space within which the spokes 16 are housed, means that the spring elements of spokes 16 form rigid beam structures under torsional loading and resist rotation of the hub 14 relative to the wheel rim 12.

In order to facilitate braking, in use, of the rotation of the hub 14 on the axle 28, the wheel 10 includes a brake disc 40 (FIG. 5) that is mounted on an outer face of the wheel mount 26 for rotation with the hub 14 in a plane generally parallel to but spaced from the hub 14. In use, on a vehicle, a brake pad would be applied to the brake disc 40 in order o generate friction and thereby brake the rotation of the hub 14 on the axle 28.

Referring to FIG. 5, it can be seen that axle 28 has a square cross-sectional. It will be appreciated, therefore, that the axle 28 will be unable to rotate when it is received, in use, in a correspondingly shaped socked in a vehicle. It is envisaged that in other embodiments, the axle 28 might extend through the centre of the wheel mount 26 so as to protrude from both sides for receipt in sockets, in use, on both sides of the hub 14.

It will also be appreciated that the electric motor 30 might be used in addition to the brake disc, or instead of the brake disc, to brake rotation of the hub 14 on the axle 28.

The lateral stability (otherwise referred to as lateral stiffness) of a wheel 10 in which the hub 14 is mounted for movement relative to the wheel rim 12 is inevitably reduced when compared with a conventional wheel construction in which the hub 14 is fixed relative to the wheel rim 12 by means of rigid spokes 16 fixedly connected at each end between the hub 14 and the wheel rim 12. It is important, therefore, that the spokes 16 locate the hub 14 relative to the wheel rim 12 in a manner that maximises lateral stability of the wheel 10 in so far as it is possible.

It will be appreciated, as outlined above, that the use of fixed connections to secure the opposing ends of each of the resilient spokes 16 to the hub 14 and the wheel rim 12 would maximise lateral stability of the resultant wheel 10. The use of fixed connections at both ends of the spokes 16, however, results in a disproportionate increase in the spring compression rate of each spoke 16 when compared with the use of the same spokes 16 with a fixed connection at the hub 14 and a hinged connection at the wheel rim 12.

When fixed hinges are used at both the hub 14 and the wheel rim 12, the hub 14 does not move relative to the wheel rim 12 to the extent required to provide an integrated suspension system unless relatively soft (i.e. relatively flexible) spokes 16 are used. This is because the use of relatively soft spokes 16 reduces the spring compression rate and thereby allows movement of the hub 14 relative to the wheel rim 12. The use of a relatively low spring compression rate is particularly necessary where the load applied to the hub 14 is relatively low, such as would be the case in a bicycle or moped.

Using relatively soft (i.e. relatively flexible) spokes 16, however, reduces the strength of the spokes 16 making them less able to resist rotation, when compared with stiffer spokes 16, of the hub 14 relative to the wheel rim 12 when the wheel 10 is driven to rotate on an axle extending through the hub 14 such that the spokes are more prone to break.

The risk would remain in higher load applications too where the spokes 16 would inevitably be subjected to larger torques in use, but effectively make lower load applications impossible to achieve.

The relatively low increase in lateral stability achieved through the use of fixed connections of the spokes 16 at both the hub 14 and the wheel rim 12 is not sufficient to offset the risk of the spokes 16 breaking in use.

Examples 1 and 2 described below illustrate how the spring compression rate and the lateral stiffness of a wheel 10 according to the invention and an identical wheel in which the hinged connections between the spokes 16 and the wheel rim 12 are replaced by fixed connection.

### EXAMPLE 1-WHEEL 10 ACCORDING TO THE INVENTION

### Spring Compression Rate

First, a wheel 10 according to the invention was mounted vertically in a mechanical tensile test rig 80 (as shown in FIG. 12) by means of an axle 86 extending generally horizontally through the hub 14 of the wheel 10. The wheel 10 included three resilient, equidistantly spaced spokes 16 formed from a laminated structure including one or more alternate layers of reinforcing material and epoxy resin. Referring to FIG. 13, the dimensions of the wheel 10 were as follows:
wheel diameter (M)=430 mm
hub diameter (N)=250 mm
spoke length (O) between connections to hub and rim=220 mm
spoke width (P)=80 mm

The thickness of each spoke 16 (not illustrated) was 7.5 mm

A load sensor 82 was brought into contact with the outer surface 84 of the wheel rim 12 at the lowest point of the wheel 10 in order to measure load on displacement of the hub 14 within the envelope of the wheel 10 towards the wheel rim 12 and the load sensor 82.

The mechanical test rig 80 included a digital vernier distance measuring system arranged to measure displacement of the hub 14 away from a rest position, where the hub 14 is located centrally relative to the wheel rim 12, on the application of a load toward the wheel rim 12.

The digital vernier distance measuring system was connected to a control box programmed to follow a pre-set test routine involving during which the wheel 10 is loaded by displacing the hub 14 relative to the wheel rim 12, towards the load sensor 82, a distance of 25 mm. The load sensor 82 measured the average force per mm of displacement whilst the wheel 10 was under load.

Repeating the test 3 times at different points around the circumference of the wheel 10 resulted in an average measurement of the spring compression rate of the wheel 10, created by the system of spokes 16 locating the hub 14 relative to the wheel rim 12, of 50.24 N/mm.

### Lateral Stiffness

Next, the wheel 10 was mounted on its side in the mechanical tensile test rig 80 by means of a vertically oriented axle 86 (shown in FIG. 14) passing through the hub 14 so that the wheel 10 was held securely on its side. In this arrangement, the load sensor 82 was located in contact with an edge 88 of the wheel rim 12 in order to measure load on displacement of the hub 14 along the axle 86 in a direction generally toward the side of the wheel 10 in contact with the load sensor 82.

The digital vernier distance measuring system was arranged to measure displacement of the hub 14 from the rest position, in which the hub 14 is located centrally relative to the wheel rim 12, in a direction parallel to the axle 86 and toward the side of the wheel 10 in contact with the load sensor 82.

The digital vernier distance measuring system was connected to a control box programmed to follow a pre-set test routine involving during which the wheel 10 is loaded by displacing the hub 14 in the direction parallel to the axle 86 and toward the side of the wheel 10 in contact with the load sensor 82, a distance of 25 mm. The load sensor 82 measured the average force per mm of displacement whilst the wheel 10 was under load.

Repeating the test 3 times at different points around the circumference of the wheel 10 resulted in an average measurement of the lateral stiffness of the wheel 10 of 19.9 N/mm.

### EXAMPLE 2-WHEEL INCLUDING FIXED CONNECTIONS BETWEEN SPOKES AND WHEEL RIM

A wheel identical in structure to wheel 10 except for the provision of a fixed connection between the end of each spoke 16 and the wheel rim 12 was then subject to the same testing in order to measure the spring compression rate and the lateral stiffness of the wheel.

Adopting identical testing procedures to those outlined above for the purposes of measuring spring compression rate and lateral stiffness resulted in the following average values:
spring compression rate=99.04 N/mm
lateral stiffness=24.41 N/mm

Accordingly, the use of a hinged connection to couple each spoke 16 to the wheel rim 12, so as to allow pivoting movement of the spokes 16 relative to the wheel rim 12, achieves a wheel 10 exhibiting a lower spring compression rate when compared with the same wheel employing identical spokes 16 but with fixed connections at both the hub 14 and the wheel rim 12.

This effect on the spring compression rate facilitates the use of stiffer—and therefore stronger—spokes 16 when the spokes 16 are hingedly connected to the wheel rim 12 because, for any given spoke 16, the use of hinged connections equates to halving of the spring compression rate whilst only reducing lateral stiffness by approximately 17%.

This in turn means that it is possible to use stiffer spokes 16 in lower load applications and so increases the ability of the spokes 16 to withstand the torques seeking to turn the hub 14 relative to the wheel rim 12 when the wheel 10 is driven to rotate on an axle extending through the hub 14 without breaking.

As illustrated schematically in FIG. 10 the use of a hinged connection to couple one end of each spoke 16 to the wheel rim 12 and a fixed connection to couple the other end of the spoke 16 to the hub 14 results in a smoother and more uniform stress distribution along the length of the spoke 16, as illustrated by force lines A, when the wheel 10 is driven to rotate on an axle (not shown) extending through the hub 14.

In contrast, as illustrated schematically in FIG. 11, the use of fixed connections to couple the ends of each spoke 16 to the wheel rim 12 and the hub 14 results in localized stress loading within the spoke 16, as illustrated by force lines A, when the wheel 10 is driven to rotate on an axle (not shown) extending through the hub 14. Such localised application of stress loading causes more rapid fatiguing of the spokes 16 and thus a greater risk of wheel failure. High stress loading of each spoke 16 will create fatigue within the structure of the spoke 16 and cause the spoke 16 eventually to fail.

The use of a hinged connection between each spoke 16 and the wheel rim 12 therefore allows for better fatigue management whilst also achieving a sufficient degree of lateral stiffness in the wheel 10.

The hinged connection between the spring element of each spoke 16 and the inner circumferential surface 20 of the wheel rim 20 of the wheel 10 shown in FIGS. 1-4. In other embodiments, however, a non-mechanical hinge might be used so as to reduce maintenance that might otherwise be required in order to maintain the pivoting movement of the spring element of each spoke 16 relative to the inner circumferential surface 20 of the wheel rim. Such a wheel 10′ is shown in FIG. 6.

Since the structure of the wheel 10′ shown in FIG. 6 is the same as the wheel 10 shown in FIGS. 1-4, except for the use of a non-mechanical hinge, like reference numerals are used to illustrate the individual components of the wheel 10′. Accordingly, the wheel 10′ will not be described in any further detail.

It is envisaged that the non-mechanical hinge might take the form of a living hinge formed from a plastics material or other composite material.

A wheel 50 according to a third embodiment of the invention is shown in FIGS. 6-8. The wheel 50 includes a wheel rim 52 and a hub 54 defining a hollow housing for a wheel mount (not shown).

The hub 54 is mounted within the wheel rim 52 via three resilient and equidistantly spaced spokes 56 extending between an outer circumferential surface 58 of the hub 54 and an inner circumferential surface 60 of the wheel rim 52. As in the embodiment shown in FIGS. 1-4, each spoke 56 is defined by a flexed, elongate spring element having a length that is greater than the radial distance C between the outer circumferential surface 58 of the hub 54 and the inner circumferential surface 60 of the wheel rim 52.

Each elongate spring is tangentially fixed at or towards one end 62 to the outer circumferential surface 58 of the hub 54 and tangentially coupled at or towards its other end 64 to the inner circumferential surface 60 of the wheel rim 52 via a hinged connection.

In the embodiment shown in FIG. 7, the hinged connection is provided by means of a non-mechanical hinge. It is envisaged that the non-mechanical hinge might be defined by a living hinge formed from a plastics material or other composite material in a similar manner to the non-mechanical hinge employed in the embodiment shown in FIG. 6.

The tangential coupling at the wheel rim 52 is spaced circumferentially from the tangential fixing at the hub 54 in an anti-clockwise direction by an angle θ.

In the embodiment shown in FIG. 7, the angle θ subtended by the connections at the opposing ends of the spring element of each spoke 56 is 110°. As with the embodiment described with reference to FIG. 1, it is envisaged that the size of angle θ might vary in other embodiments depending on the behaviour and performance required by the spring elements.

In other embodiments, the angle θ subtended by the connections at the opposing ends of the spring element of each spoke 56 may be in the range of 100° to 110°.

The equidistantly spaced arrangement of the spokes 56 means that the hub 54 is biased to a centrally located position within the wheel rim 52 in an unloaded condition whilst allowing radial movement of the hub 54 relative to the wheel rim 52 in a loaded condition.

On the application of a load to the hub 54, the spokes 16 will act to provide an integrated suspension and damping effect in the same manner as has already been described with reference to the embodiment shown in FIG. 1. Accordingly, the behaviour of the spokes 16 will not be repeated again here.

In the same manner to the embodiment shown in FIG. 1, the spring element of each spoke 56 is formed from a laminated structure including one or more alternate layers of reinforcing material and epoxy resin in order to achieve the desired resilience.

The length of the spring element of each spoke 56 is selected so that the flexure of the spring element between the tangential coupling at the wheel rim 52 and the tangential fixing at the hub 54 causes the spring element to pass through a midpoint between the outer circumferential surface 58 of the hub 54 and the inner circumferential surface 60 of the wheel rim 52 at a midpoint of the circumferential spacing of the tangential fixing at the hub 54 from the tangential coupling at the wheel rim 52. This arrangement improves the lateral stability of the wheel 50 and assists in the resistance to any twisting movement of the hub 54 relative to the wheel rim 52.

The location of the midpoint X explained previously with reference to FIG. 3 applies equally to the embodiment shown in FIG. 6 and will not be repeated again here.

The lateral stability of the wheel 50 is further improved by the radial dimension of the hub 54 relative to the radial dimension of the wheel rim 52. In the same manner as the embodiment shown in FIGS. 1 and 2, the diameter A of the hub 54 is 60% of the inside diameter B of the wheel rim 52, This results in a reduced space between the outer circumferential surface 58 of the hub 54 and the inner circumferential surface of the wheel rim 52, than might otherwise be the case with a more conventionally sized hub, to receive the spokes 56. This greatly assists in increasing the lateral stability of the wheel 60.

In other embodiments of the invention, the diameter A of the hub 54 may be between 60% and 80% of the inside diameter B of the wheel rim 52. The diameter A of the hub 54 may, for example, be 70% or 80% of the inside diameter B of the wheel rim 52. It is preferred, however, that the diameter A of the hub 54 is 60% of the inside diameter B of the wheel rim 52.

Where the embodiment shown in FIG. 7 differs from the embodiment already described with reference to FIGS. 1-4 is that it does not include a wheel mount received in the hollow housing defined by the hub 54. The hollow housing is instead empty, as can be seen from FIG. 9. The reason for this is to allow the wheel 50 to be mounted in place of a more conventional wheel via the same wheel mounting mechanism used to mount the more conventional wheel on a vehicle.

To this end, the hub 54 includes a series of apertures 70 provided in a side wall 72 in order to allow the use of bolts to secured the wheel 50 to another wheel mount.

This allows a user to benefit from the functionality of the spokes 56 received within the relatively small envelope defined between the outer circumferential surface 58 of the hub 54 and the inner circumferential surface 60 of the wheel rim 52.

1. A wheel including:
a wheel rim;
a hub defining a hollow housing for a wheel mount; and
three or more resilient and equidistantly spaced spokes extending between an outer circumferential surface of the hub and an inner circumferential surface of the wheel rim,
wherein each spoke is defined by a flexed, elongate spring element having a length that is greater than the radial distance between the outer circumferential surface of the hub and the inner circumferential surface of the wheel rim, the spring element being tangentially fixed at or towards one end to the outer circumferential surface of the hub and tangentially coupled at or towards its other end to the inner circumferential surface of the wheel rim via a hinged connection, the tangential coupling at the wheel rim being spaced circumferentially from the tangential fixing at the hub in a predetermined direction by a predetermined angle, such that the hub is biased to a centrally located position within the wheel rim in an unloaded condition whilst allowing radial movement of the hub relative to the wheel rim in a loaded condition.

2. The wheel according to claim 1 wherein the wheel includes three resilient and equidistantly spaced spokes extending between the outer circumferential surface of the hub and the inner circumferential surface of the wheel rim.

3. The wheel according to claim 1 wherein the spring element of each spoke is arranged to extend between the outer circumferential surface of the hub and the inner circumferential surface of the wheel rim such that the predetermined angle by which the tangential coupling at the wheel rim is spaced circumferentially from the tangential fixing at the hub is in the range of 100° to 110°.

4. The wheel according to claim 1 wherein the length of the spring element of each spoke is selected so that the flexure of the spring element between the tangential coupling at the wheel rim and the tangential fixing at the hub causes the spring element to pass through a midpoint between the outer circumferential surface of the hub and the inner circumferential surface of the wheel rim at a midpoint of the circumferential spacing of the tangential fixing at the hub from the tangential coupling at the wheel rim.

5. The wheel according to claim 1 wherein the radial dimension of the hub relative to the inside radial dimension of the wheel rim is selected so that the diameter of the hub is between 60% and 80% of the inside diameter of the wheel rim.

6. The wheel according to claim 5 wherein the diameter of the hub is 60% of the inside diameter of the wheel rim.

7. The wheel according to claim 1 further including a wheel mount fixed in the hollow housing defined by the hub and an axle coupled to the wheel mount for connection to a vehicle.

8. The wheel according to claim 7 wherein the wheel mount further includes an electric hub motor configured to drive rotation of the hub on the axle.

9. The wheel according to claim 7 further including a brake disc mounted on an outer face of the wheel mount for rotation with the hub in a plane generally parallel to but spaced from the hub

10. The wheel according to claim 1 wherein each spring element is tangentially coupled at or towards its other end to the inner circumferential surface of the wheel rim via a mechanical hinge.

11. The wheel according to claim 1 wherein each spring element is tangentially coupled at or towards its other end to the inner circumferential surface of the wheel rim via a non-mechanical hinge.
